(19) United States
(12) Patent Application Publication
(10) Pub. No.: US 2014/0322414 A1
(43) Pub. Date: Oct. 30, 2014

(54) APPARATUS AND METHOD FOR MOLDING AND CHILLING CHEESE

(71) Applicant: FOREMOST FARMS USA, COOPERATIVE, Baraboo, WI (US)

(72) Inventors: Jeffrey R. Young, Reedsburg, WI (US); Thomas G. Curtis, Prairie du Sac, WI (US); Merl Jones, Richland Center, WI (US); Jesse Thompson, Shawano, WI (US); John A. Haake, Waunakee, WI (US)

(73) Assignee: Foremost Farms USA, Cooperative, Baraboo, WI (US)

(21) Appl. No.: 13/871,589

(22) Filed: Apr. 26, 2013

(51) Int. Cl. A01J 25/00; A01J 25/12

(52) U.S. Cl. CPC A01J 25/008; A01J 25/12
USPC 426/515; 99/455

(57) ABSTRACT

Pasta filata cheese, such as mozzarella and provolone, is molded and chilled by delivering the warm, plastic cheese through a cheese inlet port into a plurality of molds at an inlet station. A fluid, such as chilled water, is circulated around the molds to cool the pasta filata cheese therein. After cooling to some degree, force is applied to the upper surface of the cheese in each mold to prevent a depression from forming in that surface. Thereafter upon cooling for a desired amount, the pasta filata cheese is ejected from the plurality of molds at an outlet station.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to apparatus and methods for making pasta filata cheeses, such as mozzarella and provolone; and more particularly to techniques for ensuring uniformly molded loaves of such cheese.

2. Description of the Related Art

Pasta filata (plastic curd) cheeses are Italian type cheeses in which the curd is worked to develop a fiber or string-like texture providing an elasticity to the finished cheese. This type of cheeses are kneaded while the curd is in the plastic state to develop a desired texture. The kneading is performed by a motor-driven cooker/stretcher that has an auger within a trough, in which the cheese curd is stretched and compressed as it is conveyed along the length of the trough. The kneading process is conducted at about 122° C. to impart plasticity to the cheese, but below the melting point of the cheese where the fiber structure of the cheese would be lost through melting.

After the desired texture and structure of the cheese has been developed, the kneaded, plastic cheese mass is transferred to a molder/chiller apparatus in which the mass is divided into 7 to 12 kilogram loaves and cooled to approximately 40° C. The cooled cheese loaves typically are then transferred into a tank containing cold brine in which the loaves of cheese float to prevent deformation until the cooling process is completed. e.g., when center core of the cheese loaf has reached approximately room temperature. At that point the cheese loaf is removed from the brining tank and packaged.

Occasionally while the cheese mass is cooling in the molder/chiller apparatus, a depression formed in the upper surface of the cheese loaf. Such depressions, or dimples, may form in up to twenty percent of the loafs at reasonable production speeds of the molder/chiller apparatus. The depressions create non-uniform loaves that are objectionable to the end-user who cannot produce cheese slices from that end of the loaf. Although the incidents of depressions can be reduced by slower speeds of the molder/chiller apparatus, that adversely affects the rate of production of the cheese loaves.

It is thus desirable to provide a molder/chiller apparatus that significantly reduces or eliminates instances of depressions forming in the surface of the cheese loaf.

### SUMMARY OF THE INVENTION

An apparatus for molding and chilling pasta filata cheese includes a plurality of molds, preferably each mold has an upper surface with an opening there through. A cheese inlet port is provided for delivering a warm, plastic mass of pasta filata cheese into the plurality of molds at an inlet station. A cheese outlet port is provided to enable the pasta filata cheese to pass out of the plurality of molds at an outlet station. A transporter moves the plurality of molds between the inlet and outlet stations and a plumbing system circulates a fluid around the molds travelling between the inlet and outlet stations to thereby cool the cheese.

A press applies force through the opening onto the pasta filata cheese as the plurality of molds travel between the inlet and outlet stations. Application of the force inhibits a depression from forming on the upper surface of the pasta filata cheese while cooling within the mold.

In one embodiment of the invention, the plurality of molds include a mold housing within which a plurality of mold tubes are located for receiving the plastic pasta filata cheese. The mold housing forms a cavity around the plurality of mold tubes and the plumbing system circulates the fluid through the cavity.

In another aspect of the invention, the press comprises a member that is lowered adjacent to the upper surfaces of the plurality of molds to apply the force onto the pasta filata cheese. For example, a plug may be inserted in each mold on top of the cheese and the member contacts the plugs to apply the force.

### BRIEF DESCRIPTION OF THE DRAWINGS

FIG. 1 is an exploded perspective view of an example of a cheese molder/chiller with which the present invention may be employed;

FIG. 2 is a perspective view of the cheese molder/chiller showing the components of a press according to the present invention; and

FIG. 3 is a cross section view through one mold housing of the molder/chiller.

### DETAILED DESCRIPTION OF THE INVENTION

Although the present invention is being described for use with a rotary molder/chiller, the inventive concepts can be used with other types of equipment for chilling molds containing cheese. References herein to directional relationship and movement, such as top and bottom or clockwise, refer to the relationship and movement of the components in the orientation illustrated in the drawings, which may not be the orientation and motion of the components as attached to other machinery on which the present invention is used.

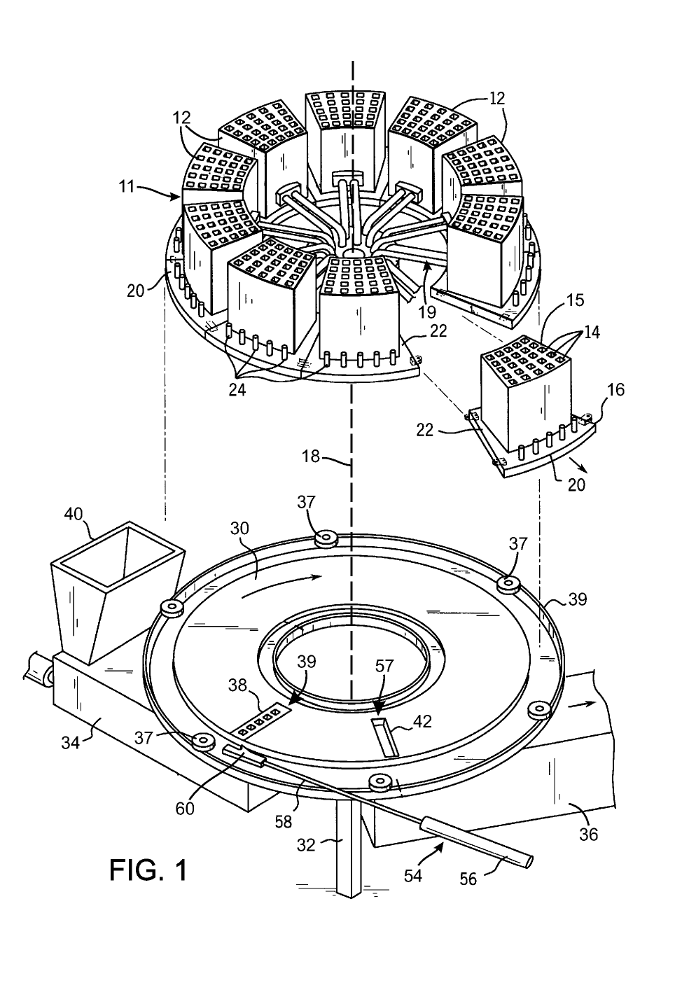

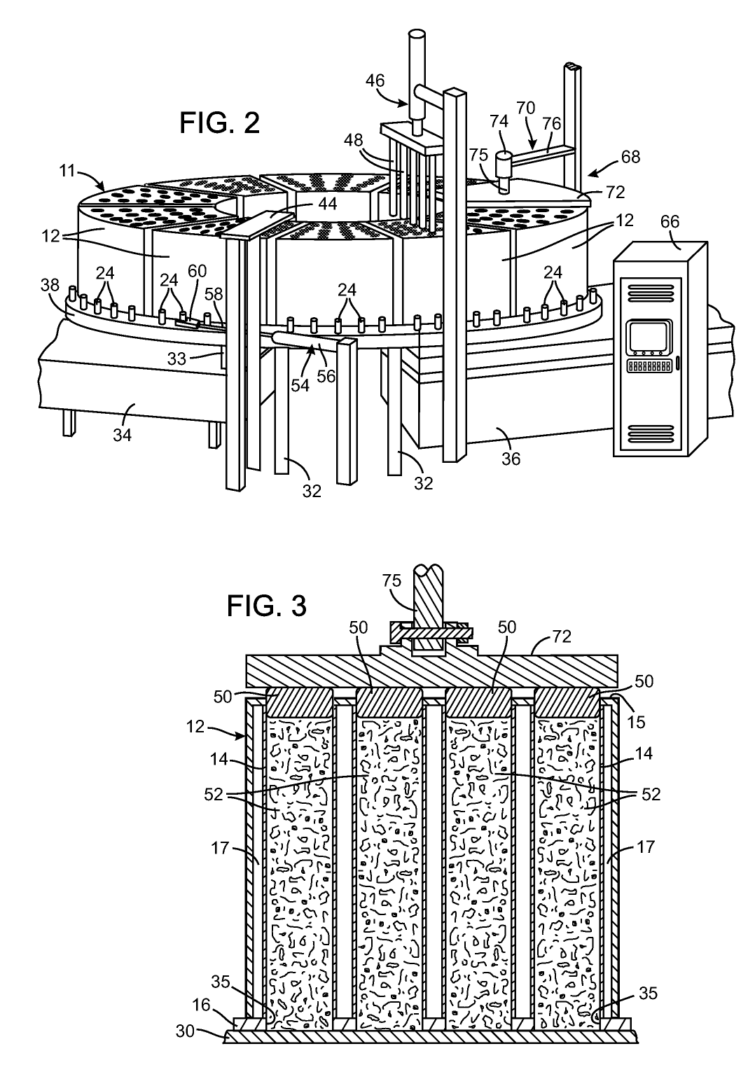

With initial reference to FIGS. 1 and 2, a molder/chiller 10 includes a number of arcuate mold housings 12, each supporting a plurality of vertically extending mold tubes 14 opening through top and bottom plates 15 and 16 of the mold housing. Each mold tube 14 forms a mold that defines the shape of a cheese loaf to be produced and each loaf typically weighs 7 to 12 kilograms. The mold housings 12 provide a cavity 17 around the mold tubes 14 thereby forming a water jacket through which chilled water flows to cool cheese that has been injected into the mold tubes. The chilled water flows through a plumbing system 19 between a water cooling device (not shown) and the mold housings 12. The terms “chilled water” and “cooled fluid” used herein refer to a liquid that has a temperature less than the temperature of the cheese within the mold tubes 14. It should be understood that other fluids than water may be used to cool the cheese within the mold tubes 14.

The bottom plate 16 of each mold housing 12 extends beyond the vertical walls of the mold housing 12 to provide a radially extending outside flange 20 and circumferentially extending side flanges 22. A plurality of vertical index pins 24, that project upward from the outside flange 20 aligned with each row of the mold tubes 14, are used for indexing rotational motion of the mold housings 12, as will be described.

The mold housings 12 fit together to form an annular wheel 11 that extends horizontally about a central axis 18. The mold tubes 14 are arranged in rows along radial lines passing through that axis 18. When the mold housings 12 are assembled together into the wheel 11 and placed on a carrier surface 30, the wheel's outer periphery formed by the outer flanges 20 engages guide rollers 37 at the perimeter of the carrier surface to guide rotation of the mold housings 12 in a regular orbit about axis 18.

The carrier surface 30 is supported above the factory floor by support beams 32 so as to allow a cheese auger assembly 34 and brine tank 36 to be placed underneath the carrier surface 30. As the mold housings 12 move on carrier surface 30 in clockwise direction about the central axis 18, they pass over radially extending cheese inlet ports 38 having equal spacing and size to one radial row of the mold tubes 14 and their apertures 35 in the bottom plate 16. The cheese inlet ports 38 are formed by an upward extending portion 33 of the cheese auger assembly 34 which receives cheese through a hopper 40 and forces the cheese through the length of an elongated housing of the cheese auger assembly by means of an internal motor-driven auger and then upward through the cheese inlet ports 38. The cheese inlet ports 38 may be replaced for different sizes and shapes of mold tubes 14 and define an inlet station 39 through which each of the rows of mold tubes 14 pass. As shown in FIG. 2, a filler plate 44 is mounted above the mold housings 12 at the inlet station 39 to limit the amount of cheese that can be injected through the inlet ports 38 into the mold tubes 14. This filler plate 44 prevents cheese from overflowing the mold tubes 14.

Displaced slightly counterclockwise from the cheese inlet ports 38 as seen in FIG. 1 is a cheese outlet port 42 positioned over the brine tank 36 to receive finished molded loaves of cheese. The cheese outlet port 42 defines an outlet station 57. With additional reference to FIGS. 2 and 3, a pneumatic cylinder set 46, having plungers 48 aligned with the centers of the mold tubes 14 in one radial line, is positioned above the outlet station 57. The plungers 48 are operated to push downward on the plugs 50 to eject formed loaves of cheese 52 through the cheese outlet port 42 in the carrier surface 30. Each plug 50 has a lateral tab or other element that prevents the plug from being ejected from the associated mold tube 14 through the bottom plate 16.

As shown in FIGS. 1 and 2, a mold driver 54 rotates the wheel 11 of mold housings 12. The mold driver 54 for example may comprise a pneumatic cylinder 56 positioned to extend an arm 58 tangentially to the rim of the wheel so formed by flanges 20. The distal end of the arm 58 includes a pawl 60 that engages the index pins 24 one at a time to rotate the mold housings 12 as the arm is extended from the cylinder 56. As the arm 58 is retracted into the cylinder 56, the pawl 60 moves to engage the next index pin 24 in the counterclockwise direction around the mold housing wheel 11. Then extending the arm 58 from the cylinder 56 again pushes the wheel 11, so that the next radial row of mold tubes 14 aligns with the cheese inlet ports 38. In that position of the wheel 11, another radial row of mold tubes 14 aligns with the cheese outlet port 42. The cylinder 56 is periodically cycled in this manner to rotate the mold housing wheel 11 around its orbit in steps. For example, the pneumatic cylinder 56 may be operated every 30 to 60 seconds depending on the characteristics of the cheese being produced. The period of that cycling is selected to ensure that the cheese in the mold tubes 14 has been cooled sufficiently by the time that row of mold tubes reaches the outlet port 42. Although the exemplary mold driver 54 comprises a pneumatic cylinder 56 and an arm 58, other mechanisms, such as a motor, for rotating the mold housing wheel 11 can be used.

The cheese auger assembly 34, pneumatic cylinders 46 and 56, and other components are operated by a control system 66 that includes an air compressor, control valves, sensors, and a computerized controller.

The molder/chiller 10 components described thus far are typical of prior commercially available apparatus for molding and chilling loaves of Italian style cheese.

The molder/chiller 10 is enhanced by a pressing station 68 at which a mold press 70 is located above the wheel 11 of mold housings 12 between the inlet and outlet stations 39 and 57 in the direction of travel of the mold housings. For example, the mold press 70 may be located between 180° and 270° clockwise, i.e., in the direction of wheel rotation, around the carrier surface 30 from the inlet ports 38, however another location may be used depending on the cheese characteristics. The mold press 70 comprises an arcuate plate 72 that generally matches the shape of the upper surface of one of the mold housings 12. The arcuate plate 72 is mounted to the distal end of a piston shaft 75 projecting from a pneumatic cylinder 74 that is attached to a support structure 76 secured to the factory floor and optionally also to the factory ceiling. Operation of the pneumatic cylinder 74 by the control system 66 raises and lowers the plate 72 with respect to the upper surfaces of a mold housings 12 and the mold tubes therein. The plate 72 is raised upward to allow the mold housing wheel 11 to rotate about around its orbit in response to operation of the mold driver 54.

With reference to FIG. 3, when wheel 11 of mold housings 12 remains stationary between times when the mold driver 54 is activated, the pneumatic cylinder 74 is operated to lower the plate 72 on top of the mold tubes 14 there below. There is a plug 50 on top of the cheese 52 in each mold tube 14. The plugs 50 extend out of the mold tubes 14, projecting slightly above the upper surface of the mold housing 12. When lowered, the plate 72 of the mold press 70 contacts the plugs. The weight of the plate 72 (e.g., 114 kilograms) and the force from the pneumatic cylinder 74 and piston shaft 75 result in a combined downward force from approximately 1 psi to approximately 5 psi of (6.894 and 34.470 kilo-pascals) being applied to each plug 50. This force prevents a depression from forming in the upper surface of the cheese 52 in each of the mold tubes 14. Thus the precise amount of force that is sufficient to preclude a depression from forming may vary from the above force range.

Application of the force by the mold press 70 also enables the rotation speed of the wheel 11 to be increased from that of conventional rotary molder/chillers, thereby increasing the throughput of the molder/chiller 10 without creating depressions in the cheese loaves.

### Industrial Applicability

The apparatus 10 described above is used to mold and chill pasta filata cheese. The cheese that has been processed in a cooker and stretcher machine is conveyed as a large homogenous mass into the hopper of the cheese auger assembly 34 in FIG. 1. The mold driver 54 periodically rotates the wheel 11 of mold housings 12. When a row of empty mold tubes 14 has moved into alignment with the inlet ports 34, as detected by a sensor, the controller 66 activates the auger assembly 34 to force cheese through the inlet ports and into those tubes. At that time, the cheese enters the mold tubes and forces the plugs 50 therein upward. When the plugs 50 contact the filler plate 44 above the mold housing 12, the force exerted on that plate is sensed thereby providing an electrical signal to the controller 66, indicating that the mold tubes 14 are now filled with cheese. In response to that signal, the controller terminates the operation of the auger 34.

The mold driver 54 continues to step the mold housing wheel 11 in a clockwise direction around the central axis 18. With each step another radial row of mold tubes 14 is filled with cheese. As the wheel 11 rotates, the plumbing system 19 is circulating chilled water through each of the cheese housings 12 and specifically through the cavity 17 around the mold tubes 14. The circulation of chilled water draws heat from the cheese within the mold tubes, thereby reducing the temperature of that cheese.

After a mold housing 12 containing cheese has traveled at least halfway around the path between the inlet station 39 and the outlet station 57, the mold housing passes beneath the press 70. While the wheel 11 remains stationary in between steps of its motion, the controller 66 activates the pneumatic cylinder 74 which lowers the plate 72 onto the plugs 50 that project slightly above the upper surface of the cheese tubes 14. This applies force to the plugs which force is transferred to the upper surface of the cheese 52 within each of those mold tubes. The plate 72 remains in that position until the next time that the mold driver 54 is to be activated. Just prior to that activation, the controller 66 operates the pneumatic cylinder 74 of the press 70 to raise the plate 72 upward away from contact with the plugs 50. The mold driver 54 then rotates the wheel 11 of mold housings 12 another step. Once the wheel 11 has stopped moving, the controller 66 operates the pneumatic cylinder 74 to again lower the plate 72 onto the plugs 50 extending from the cheese tubes 14 beneath that plate.

In the exemplary system illustrated herein, a given radial row of cheese tubes remains underneath the press plate 72 for five steps of the rotation of the cheese housing wheel 11. Therefore, pressure is applied to the upper surface of the cheese within each of those tubes for between approximately 2.5 and 5.0 minutes, depending upon the rotational speed of the wheel. In this manner, force is applied to the upper surfaces of the cheese within each mold tube 14 thereby inhibiting a depression from forming in the upper surface of the cheese and producing a uniformly shaped loaf of cheese.

The period between steps of the rotation provided by the driver 54 is selected depending upon the characteristics of the cheese being produced so that the cheese will have cooled sufficiently upon reaching the outlet port 42. This cooling ensures that each loaf upon being ejected from the mold tubes 14 into the brine tank 36 will retain its uniform shape. To accomplish that ejection, when rotation of the mold housing wheel 11 stops, the controller 66 activates the pneumatic cylinder set 47 located above the outlet port 42. That activation lowers the plungers 48 into contact with the plugs 50 in each of the cheese tubes 14 that are aligned with the outlet port 42. Continued downward motion of the plungers 48 forces the plugs 50 through the cheese tubes 14, ejecting the loaf of cheese 52 therein through the outlet port 42 and into the brine tank 36.

This process of incrementally stepping the rotation of the mold housing wheel 11 goes on. The now empty row of cheese tubes 14 continues to move clockwise from the outlet port 42 and the outlet station 57 eventually becoming aligned again with the inlet ports 38 at the inlet station 39 to receive new cheese from the auger assembly 34, thereby repeating the molding process.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. An apparatus for molding and chilling pasta filata cheese comprising:
a plurality of molds, each having an upper surface with an opening there through;
a cheese inlet port for delivering warm, plastic pasta filata cheese into the plurality of molds at an inlet station;
a cheese outlet port for enabling the pasta filata cheese to pass out of the plurality of molds at an outlet station;
a transporter for moving the plurality of molds between the inlet and outlet stations;
a plumbing system for circulating a fluid around the molds travelling between the inlet and outlet stations; and
a press for applying force through the opening onto the pasta filata cheese as the plurality of molds travel between the inlet and outlet stations.

2. The apparatus as recited in claim 1 wherein the plurality of molds comprise a mold housing within which a plurality of mold tubes are located for receiving the plastic pasta filata cheese from the cheese inlet port.

3. The apparatus as recited in claim 2 wherein the mold housing forms a cavity around the plurality of mold tubes therein; and wherein the plumbing system circulates the fluid through the cavity.

4. The apparatus as recited in claim 1 wherein the press comprises a member that is lowered adjacent to the upper surfaces of the plurality of molds to apply the force onto the pasta filata cheese.

5. The apparatus as recited in claim 1 wherein the press applies from approximately 1 psi to approximately 5 psi of force onto the pasta filata cheese.

6. The apparatus as recited in claim 1 wherein the press comprises a plate that is raised and lowered with respect to the upper surfaces of the plurality of molds.

7. The apparatus as recited in claim 6 wherein the press further comprises a pneumatic cylinder for raising and lowering the plate.

8. The apparatus as recited in claim 1 further comprising a separate plug slideably received in each of the plurality of mold tubes; and wherein the press applies the force to the plugs.

9. The apparatus as recited in claim 1 wherein the press applies the force after the plurality of molds containing the pasta filata cheese have travelled more than half way between the inlet and outlet stations.

10. A method for molding and chilling pasta filata cheese comprising:
providing a plurality of molds;
delivering warm, plastic pasta filata cheese through a cheese inlet port into the plurality of molds at an inlet station;
circulating a fluid around the molds to cool the pasta filata cheese therein;
applying force onto the pasta filata cheese within the plurality of molds; and
ejecting the pasta filata cheese from the plurality of molds at an outlet station.

11. The method as recited in claim 10 wherein the plurality of molds comprises a mold housing within which a plurality of mold tubes are located for receiving the plastic pasta filata cheese.

12. The method as recited in claim 11 wherein circulating a fluid comprises directing the fluid to flow through the mold housing and into contact with the plurality of mold tubes.

13. The method as recited in claim 10 wherein each of the plurality of molds, has an upper surface with an opening there through; and applying force applies force through the openings while the pasta filata cheese is held within the plurality of molds.

14. The method as recited in claim 10 wherein from approximately 1 psi to approximately 5 psi of force is applied to the pasta filata cheese.

15. The method as recited in claim 10 wherein the force is applied to the pasta filata cheese between approximately 2.5 and 5.0 minutes.

16. The method as recited in claim 10 wherein applying force comprises lowering a member with respect to upper surfaces of the plurality of molds.

17. The method as recited in claim 16 wherein applying force further comprises a pneumatic cylinder for lowering the member.

18. The method as recited in claim 16 further comprising providing a moveable plug within each of the plurality of mold tubes; and wherein the member applies the force to the moveable plugs.

19. The method as recited in claim 10 wherein the force is applied after the plurality of molds containing the pasta filata cheese have travelled at least half way between the inlet and outlet stations.
